(19) United States
(12) Patent Application Publication
(10) Pub. No.: US 2013/0226702 A1
(43) Pub. Date: Aug. 29, 2013

(54) CUSTOMER PURCHASE ENCOURAGEMENT SYSTEM AND METHOD

(71) Applicant: Wells Dickson BURKE, Atlanta, GA (US)

(72) Inventor: Wells Dickson BURKE, Atlanta, GA (US)

(21) Appl. No.: 13/774,187

(22) Filed: Feb. 22, 2013

Related U.S. Application Data
(60) Provisional application No. 61/603,716, filed on Feb. 27, 2012.

(51) Int. Cl. G06Q 30/02

(52) U.S. Cl. CPC G06Q 30/0259
USPC 705/14.57

(57) ABSTRACT

A customer purchase encouragement system including a transaction media reader located in a first retail store, a message database, which stores messages suitable for customers, and a Purchase Triggered Message Selection Module (PTMSM), which receives Purchase Triggered Location Data (PTLD), including the location of the first retail store at which a customer is making a purchase using the transaction media reader, and is operative to select at least one message from the message database and to provide a Proximity-based Selected Message Output (PSMO) enabling presentation of a second-store-purchase encouragement-message to the customer.

### REFERENCE TO RELATED APPLICATIONS

Reference is hereby made to U.S. Provisional Patent Application Ser. No. 61/603,716, entitled PAYMENT BASED PRESENCE NOTIFICATION, filed Feb. 27, 2012, the disclosure of which is hereby incorporated by reference and priority of which is hereby claimed pursuant to 37 CPR 1.78(a)(4) and (5)(i).

### FIELD OF THE INVENTION

The present invention relates to customer purchase encouragement systems and methodologies.

### BACKGROUND OF THE INVENTION

Various types of customer purchase encouragement systems and methodologies are known.

### SUMMARY OF THE INVENTION

The present invention seeks to provide a novel customer purchase encouragement system and methodology.

There is thus provided in accordance with a preferred embodiment of the present invention a customer purchase encouragement system including a transaction media reader located in a first retail store, a message database, which stores messages suitable for customers, and a Purchase Triggered Message Selection Module (PTMSM), which receives Purchase Triggered Location Data (PTLD) including the location of the first retail store at which a customer is making a purchase using the transaction media reader, and is operative to select at least one message from the message database and to provide a Proximity-based Selected Message Output (PSMO) enabling presentation of a second-store-purchase encouragement-message to the customer.

Preferably, the Purchase Triggered Message Selection Module (PTMSM) receives the Purchase Triggered Location Data (PTLD) from at least one of the transaction media reader, a point of sale (POS) device, a transaction processing server, a POS administration server; an in-store server and a Mobile Service Provider (MSP) server.

In accordance with a preferred embodiment of the present invention the message database stores messages received from multiple sources including at least retailers. Additionally or alternatively, the message database stores messages that are time-dependent.

Preferably, the customer purchase encouragement system also includes a Purchase Triggered Message Personalization Module (PTMPM) which receives Purchase Triggered Personalization Data (PTPD) and provides at least one Personalized Proximity-based Message Output (PPMO), which is selected and personalized to match a current location of the customer and his perceived preferences based on the PTPD. Additionally, the Purchase Triggered Message Personalization Module (PTMPM) receives Purchase Triggered Personalization Data (PTPD) from at least one of the transaction media reader, a point of sale (POS) device, a transaction processing server, a POS administration server, an in-store server and a Mobile Service Provider (MSP) server.

In accordance with a preferred embodiment of the present invention the Purchase Triggered Personalization Data (PTPD) includes data identifying the customer. Additionally, the Purchase Triggered Personalization Data (PTPD) includes at least one of the amount of the purchase, the type of goods purchased, the purchase history of the customer, and customer data entered by the customer.

Preferably, the customer purchase encouragement system also includes a display for displaying the second-store-purchase encouragement-message to the customer. Additionally, the display includes a customer mobile device. Additionally or alternatively, the display includes a display located within the first retail store.

There is also provided in accordance with another preferred embodiment of the present invention a customer purchase encouragement system including a transaction media reader located in a first retail store, a message database, which stores messages suitable for customers and a Purchase Triggered Message Personalization Module (PTMPM) which receives Purchase Triggered Personalization Data (PTPD) resulting from a purchase made by a customer using the transaction media reader and provides at least one Personalized Proximity-based Message Output (PPMO), which is selected and personalized to match the current location of the customer and his perceived preferences based on the PTPD.

There is further provided in accordance with yet another preferred embodiment of the present invention a customer purchase encouragement message delivery method including storing a plurality of messages suitable for customers in a message database, receiving Purchase Triggered Location Data (PTLD) relating to a purchase made by a customer using a transaction media reader located in a first retail store, the PTLD including the location of the first retail store, selecting at least one message from the plurality of messages based on the PTLD and providing a Proximity-based Selected Message Output (PSMO) enabling presentation of a second-store-purchase encouragement-message to the customer.

Preferably, the receiving PTLD includes receiving the PTLD from at least one of the transaction media reader, a point of sale (POS) device, a transaction processing server, a POS administration server, an in-store server and a Mobile Service Provider (MSP) server.

In accordance with a preferred embodiment of the present invention the storing a plurality of messages includes storing messages received from multiple sources including at least retailers. Additionally or alternatively, the storing a plurality of messages includes storing messages that are time-dependent.

Preferably, the customer purchase encouragement message delivery method also includes receiving Purchase Triggered Personalization Data (PTPD) and providing at least one Personalized Proximity-based Message Output (PPMO), which is selected and personalized to match a current location of the customer and his perceived preferences based on the PTPD. Additionally, the receiving PTPD includes receiving the PTPD from at least one of the transaction media reader, a point of sale (POS) device, a transaction processing server, a POS administration server, an in-store server and a Mobile Service Provider (MSP) server.

In accordance with a preferred embodiment of the present invention the receiving PTPD includes receiving data identifying the customer. Additionally, the receiving PTPD includes receiving at least one of the amount of the purchase, the type of goods purchased, the purchase history of the customer, and customer data entered by the customer.

Preferably, the customer purchase encouragement message delivery method also includes displaying the second-store-purchase encouragement-message to the customer. Additionally, the displaying includes displaying the second-store-purchase encouragement-message on a customer mobile device. Additionally or alternatively, the displaying includes displaying the second-store-purchase encouragement-message on a display located within the first retail store.

There is yet further provided in accordance with still another preferred embodiment of the present invention a customer purchase encouragement message delivery method including storing a plurality of messages suitable for customers in a message database, receiving Purchase Triggered Personalization Data (PTPD) resulting from a purchase made by a customer using a transaction media reader located in a first retail store, selecting at least one message from the plurality of messages based on the PTPD and providing at least one Personalized Proximity-based Message Output (PPMO) enabling presentation of a second-store-purchase encouragement-message to the customer.

Preferably, the customer purchase encouragement message delivery method also includes displaying the second-store-purchase encouragement-message to the customer. Additionally, the displaying includes displaying the second-store-purchase encouragement-message on a customer mobile device. Additionally or alternatively, the displaying includes displaying the second-store-purchase encouragement-message on a display located within the first retail store.

### BRIEF DESCRIPTION OF THE DRAWINGS

The present invention will be understood and appreciated more fully from the following detailed description, taken in conjunction with the drawings in which:

FIGS. 1A & 1B are simplified illustrations of a customer purchase encouragement system and typical operation thereof; and

FIG. 2 is a simplified block diagram illustration of functionality of a customer purchase encouragement server forming part of the system of FIGS. 1A & 1B.

### DETAILED DESCRIPTION OF A PREFERRED EMBODIMENT

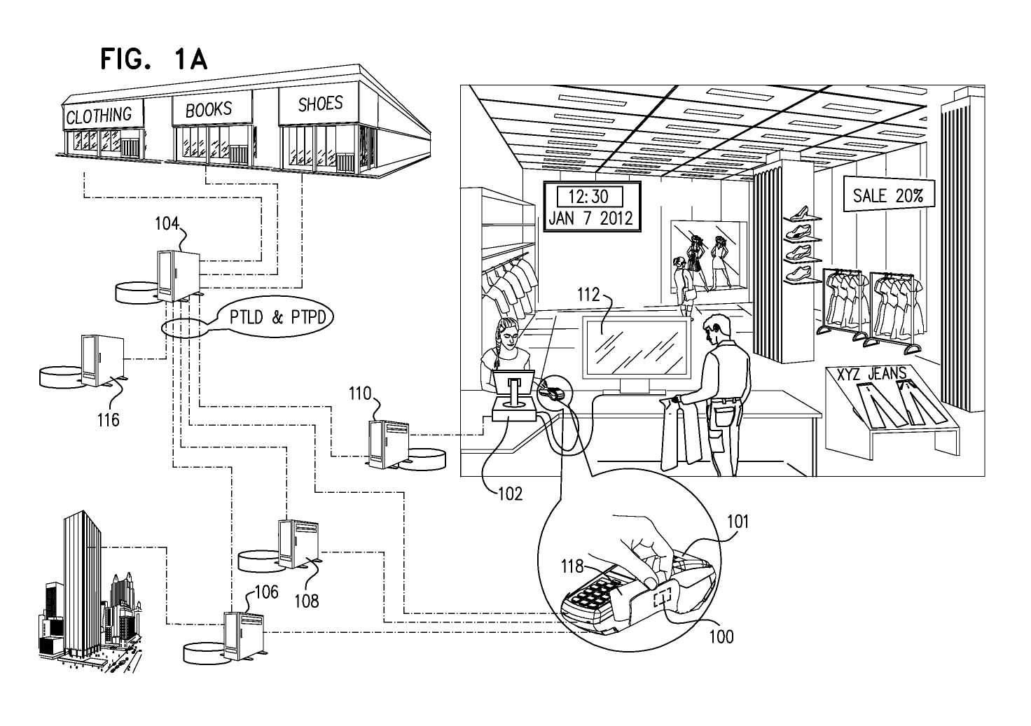

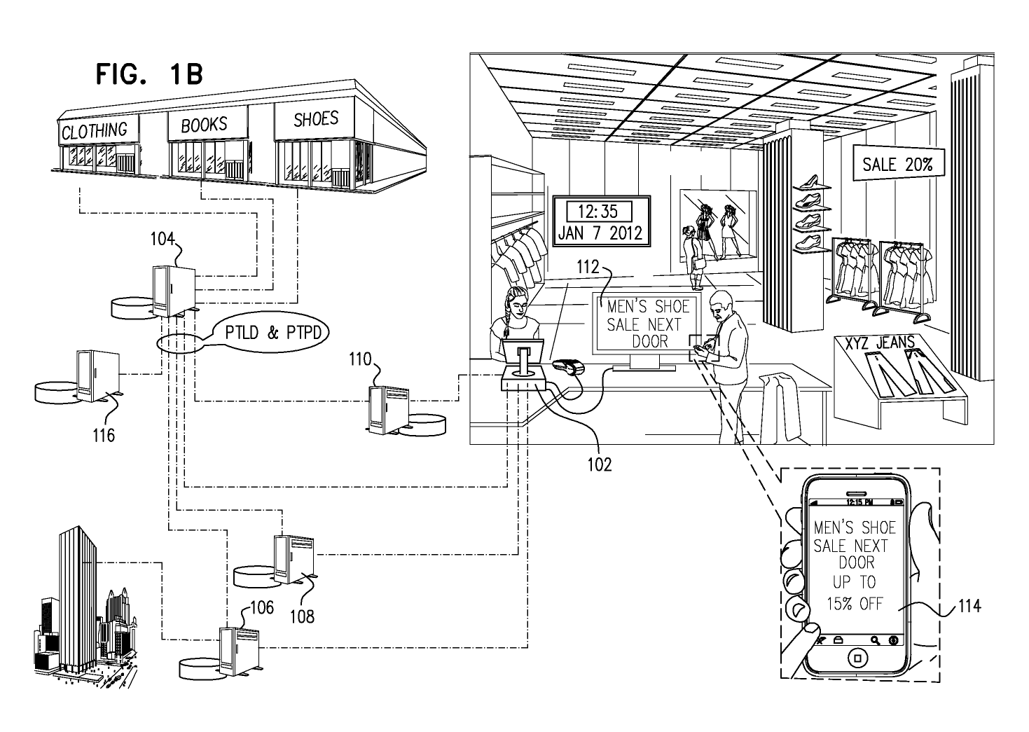

Reference is now made to FIGS. 1A, 1B & 2, which are simplified illustrations of a customer purchase encouragement system and typical operation thereof.

As seen in FIGS. 1A, 1B & 2, there is provided a customer purchase encouragement system preferably including a transaction media reader 100 located in a first retail store, such as a clothing store. It is appreciated that the transaction media reader may be of any suitable type and may be suitable for reading any one or more of a magnetic stripe card, a smart card, proximity and contactless type transaction media. Contactless transaction media may include, for example, cards and mobile communicators and preferably employs Near Field Communication (NFC) technology. The transaction media may be a credit card, a debit card, a loyalty card, a gift card or any other media which is presented in association with a proposed transaction.

The transaction media reader 100 is typically incorporated in a point of sale (POS) device 101, such as a VX 680, commercially available from VeriFone, Inc., but alternatively may communicate with a separate POS device, such as an electronic cash register 102. Typically, the POS device 101 communicates with an electronic cash register 102.

A customer purchase encouragement server 104 is provided with a message database, which stores data relating to messages suitable for communication to customers. This data may be received from multiple sources, including retailers and service providers, some of which are in mutual physical proximity, such as being in the same mall. The messages may be time-dependent but alternatively may not. The messages may include, for example, offers to purchase specific goods, invitations to visit specific stores or discounts.

It is appreciated that the customer purchase encouragement server 104 is in addition to and preferably separate from servers which are conventionally employed for effecting POS transactions, such as a transaction processing server 106, such as that operated by credit card processing companies and banks, and a POS administration server 108, such as a VERIX® server, commercially available from Verifone, Inc. There may also be provided an in-store server 110, such as a server which manages, inter alia, store inventory, sales commissions and loyalty programs, which typically communicates with electronic cash register 102. Each of these servers typically operates with one or more dedicated databases.

The customer purchase encouragement server 104 receives purchase location information and may also receive customer information from one or more of servers 106, 108 and 110 and the databases associated therewith.

Preferably, the customer purchase encouragement server 104 selects, from among the data on the message database, data enabling provision of messages which relate to stores in physical proximity to the store in which the customer is currently located and which match perceived or pre-stated customer preferences which are indicated by information received by the customer purchase encouragement server 104 from any of servers 106, 108 and 110 and/or from information supplied by the customer during registration for this service or thereafter.

In accordance with a preferred embodiment of the present invention, the customer purchase encouragement server 104 transmits second-store-purchase encouragement messages for display to the customer, preferably at the point of sale, either or both via a customer display 112 at the point of sale or via the customer's mobile communicator 114. Alternatively, the customer purchase encouragement server 104 may communicate one or more messages to a Mobile Service Provider (MSP) server 116, which forwards it to the customer's mobile communicator 114.

In a typical scenario, as seen in FIGS. 1A & 1B, a customer at a clothing store makes a purchase, here using a magnetic stripe card 118 which is swiped on transaction media reader 100 incorporated in POS device 101. Some or all of the data captured from the swipe of the magnetic stripe card is typically communicated to electronic cash register 102.

At least the customer's name may be transmitted to customer purchase encouragement server 104 from transaction media reader 100 or from POS device 101, typically via electronic cash register 102. Preferably, additional customer/transaction information, such as the location of the store, the cost of the purchase, the type of goods purchased and/or additional information identifying the customer, may be provided to the customer purchase encouragement server from one or more of servers 106, 108 and 110.

The card swipe preferably triggers receipt by the customer purchase encouragement server 104 of Purchase Triggered Location Data (PTLD) indicating the purchase location. This enables the proximity of the customer to other retail facilities to be immediately ascertained and employed in generating suitable second-store-purchase encouragement messages for display to the customer. The location of the store at which the purchase is being made may be provided by POS administration server 108, by in-store server 110 or by Mobile Service Provider server 116.

In addition, the card swipe preferably also triggers receipt and retrieval of Purchase Triggered Personalization Data (PTPD). For example, the card swipe preferably yields the customer name, which is communicated to the customer purchase encouragement server 104. Using this name, the customer purchase encouragement server 104 can pull up customer information provided by the customer when registering for this service, such as age, sex, mobile phone number and socioeconomic status. Alternatively, the customer mobile phone number may be available from in-store server 110. The purchase details, such as an indication of the goods or services purchased, may be provided either directly by the electronic cash register 102 or by the in-store server 110.

In the illustrated example, a man is purchasing trousers and based on the fact of the purchase and other customer information, the customer purchase encouragement server 104 communicates a message encouraging him to purchase shoes suitable for him at a retail facility specifically in proximity to the store where the customer is currently making a purchase. This message may appear on display 112 and/or on the customer's mobile communicator 114 at the time of the purchase of the trousers, as illustrated.

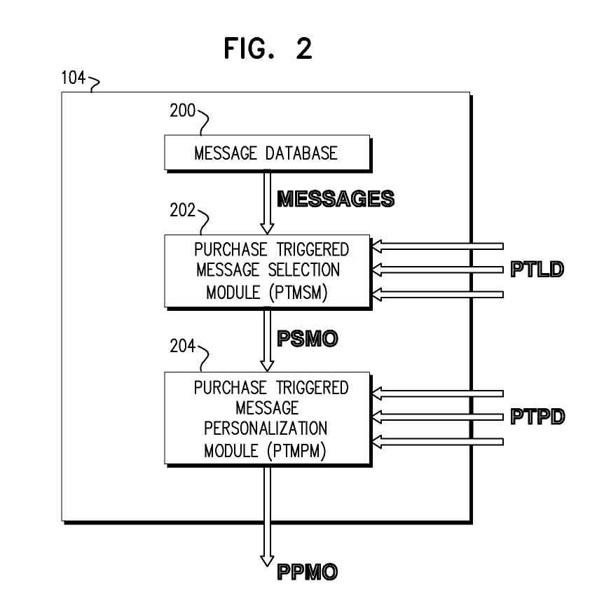

Reference is now made specifically to FIG. 2, which is a simplified block diagram illustration of transaction card read responsive computer functionality useful in the embodiment of FIGS. 1A & 1B and which may be carried by customer purchase encouragement server 104.

As seen in FIG. 2, there is preferably provided a Message Database 200, associated with customer purchase encouragement server 104 (FIGS. 1A and 1B), which stores messages suitable for customers. The messages are received from various retailers or service providers and may be time-dependent or unlimited in time.

A Purchase Triggered Message Selection Module (PTMSM) 202, preferably incorporated in customer purchase encouragement server 104, receives Purchase Triggered Location Data (PTLD) from one or more of the following sources: transaction media reader 100, POS device 101, electronic cash register 102, transaction processing server 106, POS administration server 108, in-store server 110 and MSP server 116.

The Purchase Triggered Location Data (PTLD) includes the physical location of the purchase.

Following receipt of the PTLD and based on the information therein, the Purchase Triggered Message Selection Module (PTMSM) 202 selects one or more suitable messages from the Message Database 200 and provides a Proximity-based Selected Message Output (PSMO) to a Purchase Triggered Message Personalization Module (PTMPM) 204.

Purchase Triggered Message Personalization Module (PTMPM) 204, preferably incorporated in customer purchase encouragement server 104, receives Purchase Triggered Personalization Data (PTPD) from one or more of the following sources: transaction media reader 100, POS device 101 or electronic cash register 102, transaction processing server 106, POS administration server 108, in-store server 110 and MSP server 116.

The PTPD may be communicated to customer purchase encouragement server 104 when a transaction at a first store is being made. It is appreciated that some or all of the PTPD may be pre-stored and called up by server 104 in response to the purchase.

The Purchase Triggered Personalization Data (PTPD) includes data identifying the purchaser, such as the purchaser name, mobile telephone number, email address and social media access ID. The PTPD preferably also includes one or more of the amount of the purchase, the type of goods purchased, the purchase history of the purchaser and purchaser data entered by the purchaser at any earlier time.

Following receipt of the PSMO and the PTPD and based on the information therein, the Purchase Triggered Message Personalization Module (PTMPM) 204, which is preferably incorporated in customer purchase encouragement server 104, provides one or more Personalized Proximity-based Message Outputs (PPMO), which are selected and personalized to match the current location of the purchaser and his perceived preferences. These outputs are communicated directly to display 112 or mobile communicator 114 for display to the customer. Alternatively, these outputs may be further processed before being communicated to display 112 or mobile communicator 114 for display to the customer.

It is appreciated that Message Database 200, Purchase Triggered Message Selection Module (PTMSM) 202 and Purchase Triggered Message Personalization Module (PTMPM) 204 may be incorporated in a plurality of servers communicating with each other.

It will be appreciated by persons skilled in the art that the present invention is not limited to what has been particularly shown and described hereinabove. Rather the scope of the invention includes both combinations and subcombinations of the various features described hereinabove as well as modifications and variations thereof which would occur to persons skilled in the art upon reading the foregoing description and which are not in the prior art.

1. A customer purchase encouragement system comprising:
a transaction media reader located in a first retail store;
a message database, which stores messages suitable for customers; and
a Purchase Triggered Message Selection Module (PTMSM), which receives Purchase Triggered Location Data (PTLD), including the location of said first retail store at which a customer is making a purchase using said transaction media reader, and is operative to select at least one message from said message database and to provide a Proximity-based Selected Message Output (PSMO) enabling presentation of a second-store-purchase encouragement-message to said customer.

2. A customer purchase encouragement system according to claim 1 and wherein said Purchase Triggered Message Selection Module (PTMSM) receives said Purchase Triggered Location Data (PTLD) from at least one of:
said transaction media reader;
a point of sale (POS) device;
a transaction processing server;
a POS administration server;
an in-store server; and
a Mobile Service Provider (MSP) server.

3. A customer purchase encouragement system according to claim 1 and wherein said message database stores messages received from multiple sources including at least retailers.

4. A customer purchase encouragement system according to claim 1 and wherein said message database stores messages that are time-dependent.

5. A customer purchase encouragement system according to claim 1 and also comprising a Purchase Triggered Message Personalization Module (PTMPM) which receives Purchase Triggered Personalization Data (PTPD) and provides at least one Personalized Proximity-based Message Output (PPMO), which is selected and personalized to match a current location of said customer and his perceived preferences based on said PTPD.

6. A customer purchase encouragement system according to claim 5 and wherein said Purchase Triggered Message Personalization Module (PTMPM) receives Purchase Triggered Personalization Data (PTPD) from at least one of:
said transaction media reader;
a point of sale (POS) device;
a transaction processing server;
a POS administration server;
an in-store server; and
a Mobile Service Provider (MSP) server.

7. A customer purchase encouragement system according to claim 5 and wherein said Purchase Triggered Personalization Data (PTPD) includes data identifying said customer.

8. A customer purchase encouragement system according to claim 7 and wherein said Purchase Triggered Personalization Data (PTPD) includes at least one of the amount of the purchase, the type of goods purchased, the purchase history of the customer, and customer data entered by the customer.

9. A customer purchase encouragement system according to claim 1 and also comprising a display for displaying said second-store-purchase encouragement-message to said customer.

10. A customer purchase encouragement system according to claim 9 and wherein said display comprises a customer mobile device.

11. A customer purchase encouragement system according to claim 9 and wherein said display comprises a display located within said first retail store.

12. A customer purchase encouragement system comprising:
a transaction media reader located in a first retail store;
a message database, which stores messages suitable for customers; and
a Purchase Triggered Message Personalization Module (PTMPM) which receives Purchase Triggered Personalization Data (PTPD) resulting from a purchase made by a customer using said transaction media reader and provides at least one Personalized Proximity-based Message Output (PPMO), which is selected and personalized to match the current location of the customer and his perceived preferences based on said PTPD.

13. A customer purchase encouragement message delivery method comprising:
storing a plurality of messages suitable for customers in a message database;
receiving Purchase Triggered Location Data (PTLD) relating to a purchase made by a customer using a transaction media reader located in a first retail store, said PTLD including the location of said first retail store;
selecting at least one message from said plurality of messages based on said PTLD; and
providing a Proximity-based Selected Message Output (PSMO) enabling presentation of a second-store-purchase encouragement-message to said customer.

14. A customer purchase encouragement message delivery method according to claim 13 and wherein said receiving PTLD comprises receiving said PTLD from at least one of:
said transaction media reader;
a point of sale (POS) device;
a transaction processing server;
a POS administration server;
an in-store server; and
a Mobile Service Provider (MSP) server.

15. A customer purchase encouragement message delivery method according to claim 13 and wherein said storing a plurality of messages comprises storing messages received from multiple sources including at least retailers.

16. A customer purchase encouragement message delivery method according to claim 13 and wherein said storing a plurality of messages comprises storing messages that are time-dependent.

17. A customer purchase encouragement message delivery method according to claim 13 and also comprising:
receiving Purchase Triggered Personalization Data (PTPD); and
providing at least one Personalized Proximity-based Message Output (PPMO), which is selected and personalized to match a current location of said customer and his perceived preferences based on said PTPD.

18. A customer purchase encouragement message delivery method according to claim 17 and wherein said receiving PTPD comprises receiving said PTPD from at least one of:
said transaction media reader;
a point of sale (POS) device;
a transaction processing server;
a POS administration server;
an in-store server; and
a Mobile Service Provider (MSP) server.

19. A customer purchase encouragement message delivery method according to claim 17 and wherein said receiving PTPD comprises receiving data identifying said customer.

20. A customer purchase encouragement message delivery method according to claim 19 and wherein said receiving PTPD comprises receiving at least one of the amount of the purchase, the type of goods purchased, the purchase history of the customer, and customer data entered by the customer.

21. A customer purchase encouragement message delivery method according to claim 13 and also comprising displaying said second-store-purchase encouragement-message to said customer.

22. A customer purchase encouragement message delivery method according to claim 21 and wherein said displaying comprises displaying said second-store-purchase encouragement-message on a customer mobile device.

23. A customer purchase encouragement message delivery method according to claim 21 and wherein said displaying comprises displaying said second-store-purchase encouragement-message on a display located within said first retail store.

24. A customer purchase encouragement message delivery method comprising:
storing a plurality of messages suitable for customers in a message database;
receiving Purchase Triggered Personalization Data (PTPD) resulting from a purchase made by a customer using a transaction media reader located in a first retail store;
selecting at least one message from said plurality of messages based on said PTPD; and
providing at least one Personalized Proximity-based Message Output (PPMO) enabling presentation of a second-store-purchase encouragement-message to said customer.

25. A customer purchase encouragement message delivery method according to claim 24 and also comprising displaying said second-store-purchase encouragement-message to said customer.

26. A customer purchase encouragement message delivery method according to claim 25 and wherein said displaying comprises displaying said second-store-purchase encouragement-message on a customer mobile device.

27. A customer purchase encouragement message delivery method according to claim 25 and wherein said displaying comprises displaying said second-store-purchase encouragement-message on a display located within said first retail store.
